(19) United States
(12) Patent Application Publication
(10) Pub. No.: US 2026/0249701 A1
(43) Pub. Date: Aug. 27, 2026

(54) SHORT-CIRCUIT PROTECTION WITH A SEMICONDUCTOR SWITCH

(71) Applicant: Siemens Mobility GmbH, München (DE)

(72) Inventor: Maik Dittrich, Erlangen (DE)

(21) Appl. No.: 19/161,797

(22) PCT Filed: Feb. 27, 2024
(86) PCT No.: PCT/EP2024/054909

§ 371 Date: Sep. 3, 2025

(30) Foreign Application Priority Data
Mar. 3, 2023 (DE) 10 2023 201 951.5

(51) Int. Cl. B60L 3/00; B60L 3/04; B60L 58/21; H02H 3/08; H02H 7/18; H02J 7/60

(52) U.S. Cl. CPC B60L 3/0046; B60L 3/0069; B60L 3/04; B60L 58/21; H02H 3/08; H02H 7/18; H02J 7/663; B60L 2200/26; B60L 2210/44; B60L 2240/549

(57) ABSTRACT

A protective circuit for a traction accumulator with a positive pole and a negative pole. The protective circuit has a semiconductor circuit breaker which is electrically connected to the positive pole of the traction accumulator. There is also described a power supply device and an electrically driven vehicle. In addition, there is also described a method for producing a protective circuit for a traction accumulator.

The invention relates to a protective circuit for a traction accumulator. The invention further relates to a power supply device. The invention moreover relates to an electrically powered vehicle. The invention additionally relates to a method for producing a protective circuit for a traction accumulator.

Accumulators for the operation of vehicles, also described hereinafter as traction batteries or traction accumulators, require occasional electric charging. To this end, a vehicle, for example a rail vehicle, comprises additional power electronics. For example, in a rail vehicle, a DC/DC converter is customarily connected between the traction battery and a “traction DC link”.

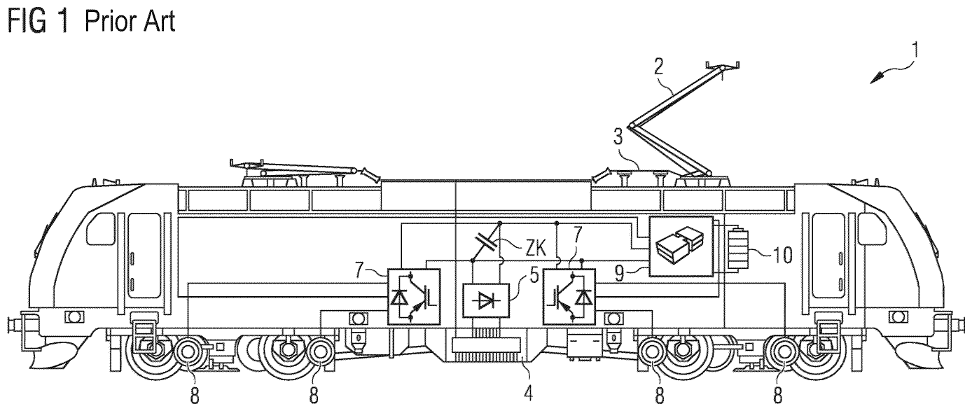

An electrified rail vehicle having a three-phase current drive, as exemplarily represented in FIG. 1, comprises a “load current converter”. This load current converter comprises the above-mentioned traction DC link, which is connected between the high-voltage supply from the traction power supply grid and the three-phase current drive or three-phase current-powered traction device. A traction DC link of this type customarily assumes a DC voltage of 2 to 4 kV. Conversely, the load-dependent terminal voltage of a traction battery is customarily significantly lower, typically <1 kV. For the conversion of the electric voltage between these different values, in general, the above-mentioned DC/DC voltage converter is employed. Further components, which are indirectly contact-connected to the traction battery via the traction DC link, are a four-quadrant converter, by means of which the grid current of the traction power supply grid, for example an AC current, is converted into a DC current at the DC voltage of the traction DC link, and a pulse-controlled drive converter in the form of a pulse-controlled inverter which converts the DC current of the traction DC link into the multi-phase AC current of the drive motors of the rail vehicle. The traction DC link and all the above-mentioned units, which units are electrically connected to the traction DC link, and the intervening power connection lines, are susceptible to damage, and may be affected by short-circuits.

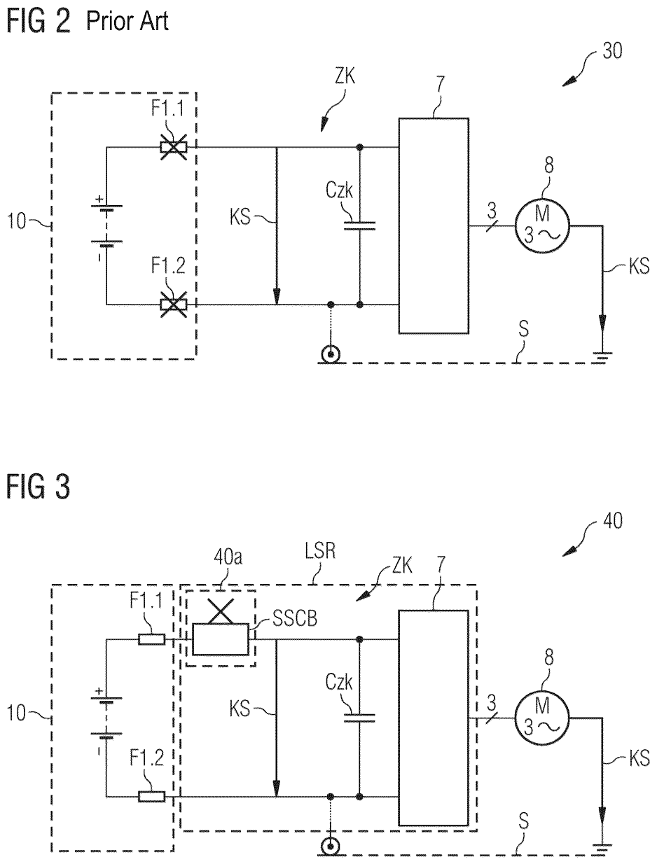

In many cases, vehicles having traction batteries therefore comprise an overcurrent protection element, for example a quick-acting fusible link, for the short-circuit protection of the traction battery. Fusible links of this type are represented in FIG. 2. In general, a rail vehicle, for each drive motor unit, i.e. per bogie, comprises only one central traction DC link. A short-circuit in a central traction DC link of this type, or a simple ground fault in vehicles having a grounded traction DC link (corresponding to a short-circuit to ground), consequently results in the common tripping of all overcurrent protection elements or fuses for the drive motor unit concerned.

Non-selective protective reactions of this type associated with short-circuits in the traction DC link result in a not insignificant impairment of vehicle availability, with associated disadvantages for the vehicle operator such as, for example, interruptions of service and spare part replacement costs.

Conventional mechanical high-speed DC circuit-breakers for fuse protection functions have the following disadvantages:
excessively slow switching which, in the event of low inductance values in the affected current circuits, results in very high opening overcurrents;
high-speed DC circuit-breakers are large and heavy.

Such mechanical high-speed circuit-breakers, of the UR10/UR15 type, are described in https://www.secheron.com/wp-content/uploads/2021/10/-SG104136BDE_C04_Brochure_Circuit-breaker-DC_UR10-15_08.20.pdf. UR10 and UR15 are current limiting singlepole DC power breakers with natural cooling, of bidirectional design with trip-free release, an electromagnetic blowout arrangement, electrical control circuits and a direct instantaneous overcurrent release.

Fuses based upon the principle of pyrotechnic interruption, or “pyrofuses”, have the following disadvantages:
once a fuse of this type is tripped, it can no longer be reset;
the employment of explosives is associated with unforeseeable consequences.

Moreover, conventional individual SSCBs (solid state circuit-breakers) are employed for stationary industrial applications, but not for traction accumulators.

The object is therefore the provision of a protective circuit for a battery-based power supply of a vehicle which at least partially overcomes the above-mentioned issues associated with battery-based power supply devices for vehicles having conventional circuit breakers.

This object is fulfilled by a protective circuit for a traction accumulator as claimed in patent claim 1, by a power supply device as claimed in patent claim 12, by an electrically powered vehicle as claimed in patent claim 13, and by a method for producing a protective circuit for a traction accumulator as claimed in patent claim 14.

The protective circuit for a traction accumulator according to the invention comprises a semiconductor-based circuit-breaker. The traction accumulator has a positive pole and a negative pole. The semiconductor-based circuit-breaker is electrically connected to the positive pole of the traction accumulator. It should be observed that, preferably, between the positive pole of the traction accumulator and the semiconductor-based circuit-breaker, a conventional one-off fuse is further arranged, which one-off fuse preferably comprises a fusible link. In general, this one-off fuse is already assigned to the traction accumulator or is an element of this traction accumulator. The traction accumulator is preferably configured for employment in a rail vehicle. A semiconductor-based circuit-breaker is to be understood as an electronic circuit-breaker, the switching behavior of which for the prevention of overcurrents or overvoltages is based upon the specific electronic properties of different semiconductor materials, in particular of differently doped semiconductor materials. A semiconductor-based circuit-breaker comprises semiconductor-based components, preferably diodes, in particular reverse-bias diodes, and transistors.

A protective circuit of this type, having a semiconductor-based circuit-breaker, provides an advantage over a protective circuit having a one-time fuse, wherein the semiconductor-based circuit-breaker can be employed multiple times, without the necessity for replacement. In particular, if the circuit-breaker is employed in combination with a one-time fuse, i.e. is connected in series with a one-time fuse of this type, the flexibility and the low maintenance requirements of the semiconductor-based circuit-breaker can be combined with the high security and reliability of the one-time fuse. In particular, in case of the majority of events involving the occurrence of an overcurrent, activation of the one-time fuse, and the subsequent necessity for a maintenance procedure which, for example, includes a replacement of the one-time fuse, can be avoided. Moreover, a semiconductor-based circuit-breaker of this type provides the advantage of a high tripping speed. Thus, in the event of a combination of the semiconductor-based circuit-breaker according to the invention with a one-time fuse, a “burn-out” of the one-time fuse, including in the event of the employment of a super quick-acting fusible link as a one-time fuse, and even in the event of low-inductance short-circuits, is advantageously prevented, as the semiconductor-based circuit-breaker trips promptly, in advance of the response of the one-time fuse. Moreover, by the rapid switching of the semiconductor-based circuit-breaker, a reduction of the amplitude of a short-circuit current can also be achieved.

The protective circuit according to the invention, in combination with the traction accumulator, forms a “quasi-short-circuit-proof traction battery”. This applies on the grounds that the semiconductor-based circuit-breaker can preferably be tripped and reset for as many times, arbitrarily, as a short-circuit occurs in the traction DC link.

The power supply device according to the invention comprises a traction accumulator having a positive pole and a negative pole. The power supply device according to the invention moreover comprises a protective circuit according to the invention, the semiconductor-based circuit-breaker of which is electrically connected to the positive pole of the traction accumulator. The power supply device according to the invention additionally comprises a DC-based traction DC link which is electrically connected to the positive pole of the traction accumulator. The power supply device according to the invention moreover comprises a pulse-controlled drive inverter for transforming the direct current of the traction DC link into the three-phase AC current for traction. The power supply device according to the invention preferably comprises a “traction power converter”, also described as a load current converter, which converter comprises the above-mentioned components and thus, in particular, the DC-based traction DC link and the pulse-controlled drive inverter, together with the protective circuit.

A traction accumulator is to be understood as a rechargeable electrical energy storage device which, in conjunction with the power supply device according to the invention, is employed for the grid-independent supply of traction devices, in particular of drive motors, and particular of other electrical functional units of a rail vehicle. A traction accumulator of this type comprises a plurality of parallel- and serially-interconnected accumulator cells, and is configured as a high-voltage battery for the delivery of high electric currents, in order to enable the delivery of sufficient power for the traction of a vehicle, in particular of a rail vehicle. In this context, electric voltages of 400 volts to 1,000 volts are customary rated voltages for enabling the propulsion of heavy vehicles such as, for example, rail vehicles. Customarily, a traction accumulator also comprises a “battery management system”, by means of which an overloading of individual cells during the extraction of energy is prevented. Traction devices comprise electric motors for propelling the drive wheels of the rail vehicle. For the supply of traction devices with electric current at an appropriate electric voltage, the power supply device comprises the above-mentioned traction DC link. In general, a traction DC link of this type is an element of the above-mentioned load current converter, which converter executes a current/voltage conversion between the current of the traction power supply grid or the current of a traction accumulator and the generator units of the rail vehicle.

As mentioned above, the traction DC link is connected between the high-voltage power supply from the traction power supply grid and the three-phase current drive or a traction device which is operated by means of three-phase current. A traction DC link of this type customarily assumes a DC voltage of 2 to 4 kV, and supplies a DC voltage. For the generation of a DC voltage, the power electronics of a rail vehicle also comprise a “four-quadrant converter” which is connected between the overhead line system and the traction DC link, and which can also be incorporated in the load current converter. Drive motors of the traction devices are customarily operated by means of three phase current, whereas traction current from the traction power supply grid is extracted at a higher electric voltage, for example 15 kV or 25 kV.

The pulse-controlled drive inverter of the power supply device according to the invention is an element of the load current converter, and converts the direct current of the traction DC link into the three-phase current which is required by a drive motor or by multiple drive motors of traction devices. Additionally, for the transmission of three-phase current to the drive motors, the power supply device according to the invention preferably comprises a three-phase conductor system for supplying one or more drive motors, which conductor system is electrically connected to the pulse-controlled drive inverter. In traction operation, the pulse-controlled drive inverter converts the DC voltage of the DC link into a three-phase voltage of variable amplitude, frequency and phase for a drive motor, in particular a three-phase machine (asynchronous or synchronous motor), and executes the control thereof with respect to speed and torque.

A pulse-controlled drive inverter of this type can be respectively configured for an individual drive motor. According to this variant, which is also described as a single-axle supply, a separate pulse-controlled drive inverter is provided for each drive motor. This arrangement provides an advantage, in that individual drive motors, or the torque and wheel-rail slip thereof, can be individually controlled or regulated. According to an alternative variant, a common pulse-controlled drive inverter can also be provided for multiple drive converters or for all the drive motors. According to this variant, which is also described as a group supply, the capacity of the pulse-controlled drive inverter is selected with a sufficient magnitude such that multiple drive motors, and preferably all the drive motors, can be actuated in tandem by means of a common pulse-controlled drive inverter. Correspondingly, the traction DC link can also be configured as a common traction DC link, or multiple traction DC links for respective individual drive motors can be incorporated in the load current converter or in the power supply device according to the invention.

The power supply device according to the invention shares the advantages of the protective circuit according to the invention.

The electrically powered vehicle according to the invention, preferably a rail vehicle, comprises a traction device and the power supply device according to the invention for supplying energy to the traction device. The electrically powered vehicle according to the invention shares the advantages of the power supply device according to the invention.

In the method according to the invention for producing a protective circuit for a traction accumulator which comprises a positive pole and a negative pole, a semiconductor-based circuit-breaker is produced. Moreover, the semiconductor-based circuit-breaker is electrically connected to the positive pole of the traction accumulator. Advantageously, according to the invention, a protective circuit is thus provided for a traction battery having a protective fuse against overvoltages and excessively high currents, which fuse can be arbitrarily employed as many times as necessary, and which requires a lower maintenance effort than conventional fuses.

The dependent claims and the subsequent description respectively include particularly advantageous configurations and further developments of the invention. In particular, the dependent claims in one category of claims can be further developed in an analogous manner to the dependent claims of another category of claims, and in an analogous manner to the descriptive elements thereof. Additionally, in the context of the invention, various features of different exemplary embodiments and claims can also be combined to form new exemplary embodiments.

According to one configuration of the protective circuit according to the invention for a traction accumulator, the semiconductor-based circuit-breaker preferably comprises a high-speed current measurement unit. Advantageously, by means of the current measurement unit, a strong current rise and, in particular, a short-circuit current in the semiconductor-based circuit-breaker can be measured. A high-speed measurement of a current rise enables a rapid interruption of a current infeed, such that a high degree of selectivity with respect to a super quick-acting fusible link is achieved, even in the event of low-inductance short-circuits. In this context, the term “high-speed” signifies that a current rise can be measured promptly, in advance of the response of a one-time fuse to the current rise.

Particularly preferably, the semiconductor-based circuit-breaker comprises an evaluation and actuation component, by means of which the circuit-breaker, according to a measurement result of the current measurement unit, can be switched to a non-conducting state or to a conducting state.

In a likewise preferred manner, cooling of the semiconductor-based circuit-breaker is executed by means of a cooling plate. The cooling plate is preferably configured as a common cooling plate for the circuit-breaker and additional components, in particular for the current measurement unit and the evaluation and actuation component. By means of a common arrangement on a common cooling plate, the overall layout is simplified.

Moreover, the circuit-breaker of the protective circuit ac-cording to the invention preferably comprises a supplementary protective element. The supplementary protective element is designed to limit voltage spikes, and preferably comprises a “snubber capacitor” or a varistor. Advantageously, rapid and substantial voltage rises are thus pre-vented, as a result of which the durability of the circuit-breaker is improved.

According to one configuration of the protective circuit according to the invention for a traction accumulator, the semiconductor-based circuit-breaker comprises an input and an output, and the input of the semiconductor-based circuit-breaker is preferably electrically connected to the positive pole of the traction accumulator. An “input” is understood as the terminal of the semiconductor-based circuit-breaker to which an influx of a direct electric current is delivered, and an output is understood as the terminal of the semiconductor-based circuit-breaker at which an outflow of a direct electric current is delivered. As described in detail hereinafter, the input and output of the semiconductor-based circuit-breaker, according to a specific requirement, can be connected in a flexible manner.

The semiconductor-based circuit-breaker preferably comprises a plurality of individual switches. Advantageously, a plurality of individual switches, in comparison with a single switch, enable the management of a higher electrical capacity. Moreover, by means of different individual switches, different sources and loads can be electrically connected. This arrangement is advantageous in the event of a modular layout of a power supply device having a plurality of parallel-connected energy storage devices and/or a plurality of parallel-connected electrical loads. Parallel-connected energy storage devices preferably comprise parallel-connected modules, also described as battery modules or accumulator modules. Electrical loads, in particular, can comprise parallel-connected traction DC links and traction devices which are connected thereto i.e. drive motors.

Thus, according to a preferred variant of the protective circuit according to the invention, the traction accumulator preferably comprises a plurality of parallel-connected (battery) modules, at least two of which are electrically connected to different individual switches of the semiconductor-based circuit-breaker. An accumulator customarily comprises a “battery pack”. The battery pack comprises a battery management system, by means of which the operation of the accumulator is monitored and controlled. The battery pack generally comprises a plurality of battery modules, also described as “modules” for short, which modules respectively comprise a housing for a plurality of battery cells. A battery module comprises a serial/parallel combi nation of battery cells. The modular layout enables a flexible scaling of an accumulator, i.e. a flexible adaptation to a desired energy storage capacity. As the circuit-breaker of the protective circuit according to the invention preferably comprises a plurality of parallel-connected individual switches, these switches can be individually electrically connected to different modules of the traction accumulator, such that individual modules can be selectively protected and, optionally, unaffected modules can continue to operate, even in the event of a short-circuit.

Preferably, if the circuit-breaker comprises a plurality of individual switches, the individual switches respectively comprise a supplementary protective element of this type.

Individual switches are preferably arranged on a common heat sink, which arrangement enables a simplified layout, in comparison with a separate cooling of individual components.

According to one configuration of the traction accumulator according to the invention, each of the semiconductor-based circuit-breakers comprises a preferably high-speed current measurement unit. Advantageously, by means of the current measurement unit, a strong current rise and, in particular, a short-circuit current in the individual switches can be individually measured for each phase. In this context, the term “high-speed” signifies that a current rise can be measured promptly, in advance of the response of a one-time fuse to the current rise.

Particularly preferably, each of the individual switches comprises an evaluation and actuation component, by means of which the respective individual switch, according to a measurement result of the current measurement unit, can be switched to a non-conducting state or to a conducting state. Advantageously, individual modules of the traction accumulator or individual phases can be deliberately switched-out in the event of the detection of a short-circuit, and operation of all the remaining modules or phases can be maintained.

In a particularly preferred manner, each of the parallel-connected modules is electrically connected to a different individual switch of the semiconductor-based circuit-breaker. Advantageously, a separate phase can be assigned to each of the modules. Advantageously, defective modules can be individually and deliberately actuated or disconnected, wherein the operation of the remaining modules is maintained.

According to one variant of the protective circuit according to the invention, the output of the circuit-breaker comprises a plurality of parallel-connected terminals or phases, each of which is connected to at least one of the parallel-connected individual switches. Advantageously, a plurality of different electrical loads can be supplied with energy in parallel. Individual circuit-breakers can thus be assigned to independent traction DC links and loads.

It is likewise preferred that the number of terminals or phases at the input of the circuit-breaker is lower than the number of parallel-connected individual switches. According to this variant, the phases or terminals of multiple individual switches are consolidated, in order to supply one or more loads with a particularly high current, or to supply a particularly high energy demand. It can also occur that the traction battery comprises fewer modules than the circuit-breaker comprises individual switches. Even under this circumstance, it can be appropriate that a smaller number of terminals are provided at the input than the number of individual switches.

The output of the circuit-breaker preferably comprises exactly one terminal or one phase, which terminal or phase is electrically connected to the plurality of parallel-connected individual switches. According to this variant, the plurality of circuit-breakers, in graphic terms, are consolidated or combined in a single phase, in order to execute a particularly comprehensive energy supply of an individual load. This variant can be employed in the event of the interconnection of a traction accumulator with exactly one single traction DC link. This variant is advantageous, in that the optimum utilization of the requisite circuit-breaker chip surface is enabled.

The input of the circuit-breaker preferably comprises a number of parallel terminals, and the number of terminals of the input is equal to the number of parallel-connected individual switches of the semiconductor-based circuit-breaker. According to this variant, all the individual switches are actuated by means of a separate terminal or a separate phase. In general, in a configuration of this type, the number of modules of the traction accumulator corresponds to the number of individual switches. Advantageously, the entire switching capacity of the circuit-breaker is utilized, with a maximum selectivity of modules.

According to one variant of the protective circuit according to the invention, the input of the semiconductor-based circuit-breaker comprises a number of parallel terminals, and the number of terminals of the input is lower than the number of parallel-connected individual switches of the semiconductor-based circuit-breaker. According to this variant, not all the individual switches are separately actuated. In general, in a protective circuit of this type, the number of modules of the traction accumulator is lower than the number of parallel-connected individual switches of the semiconductor-based circuit-breaker. Optionally, one module can be connected to multiple individual switches, such that the current capacity per module, in comparison with the connection of an individual module, in each case, is only increased by a single individual switch.

According to a specific variant of the protective circuit according to the invention for a traction accumulator, the input comprises exactly one terminal. According to this variant, the semiconductor-based circuit-breaker is actuated in the manner of a single monolithic switch with a maximum load-carrying capability or current capacity for one phase at the input thereof. If the circuit-breaker also comprises only one phase at the output thereof, on which multiple, or even all the individual switches are consolidated, the circuit-breaker also behaves in the manner of a single switch at the output thereof. Alternatively, it is also conceivable that quantities of current at the output are distributed over multiple loads, for example for the actuation of multiple traction DC links.

According to one variant of the protective circuit according to the invention for a traction accumulator, the number of terminals is equal to the number of parallel-connected modules of the traction accumulator. According to this variant, all the terminals are connected to modules of the traction accumulator. However, it is not necessary for the number of terminals to correspond to the number of individual switches. For example, multiple switches can be routed in parallel to a single terminal. Multiple independent switches can thus be configured, each of which comprises a plurality of parallel-combined switches, having an increased capacity. In the latter case, the number of terminals is lower than the number of parallel-connected individual switches.

According to a particularly specific configuration of the protective circuit according to the invention, the circuit-breaker comprises a plurality of individual switches, preferably six parallel-connected individual switches. Each of the preferably six individual switches comprises a transistor and a reverse-bias diode which is parallel-connected thereto. Each individual switch further comprises a supplementary protective element. The supplementary protective element is designed to limit voltage spikes, and is preferably implemented in the form of a “snubber capacitor” or a varistor. Individual switches are preferably arranged on a common heat sink. Moreover, the circuit-breaker preferably comprises a high-speed current measurement unit, and an evaluation and actuation component. Cooling of the circuit-breaker is preferably executed by means of a cooling plate. In order to enable the individual disconnection of each phase, the current in each individual switch is evaluated, and each individual switch can be individually actuated. Advantageously, by means of the supplementary protective element, an occurrence of potentially damaging voltage spikes is prevented. The high-speed current measurement unit and an appropriate evaluation and actuation component enable a particularly well-adapted and rapid response of the circuit-breaker to a potentially damaging current, prior to any response of a one-time fuse.

According to one configuration of the method according to the invention for producing a protective circuit for a traction accumulator, a semiconductor-based circuit-breaker for a traction accumulator is produced, which traction accumulator comprises a plurality of modules, i.e. energy storage modules, preferably six modules. The semiconductor-based circuit-breaker is configured with a plurality of parallel-connected individual switches, one input and one output.

Thereafter, the modules of the traction accumulator, on the positive pole-side, are electrically connected to the input of the semiconductor-based circuit-breaker. The individual switches of the semiconductor-based circuit-breaker are thus respectively electrically connected to the various modules of the traction accumulator.

Moreover, a connection of the output of the semiconductor-based circuit-breaker to one or more traction DC links is executed wherein, preferably, all the individual switches are consolidated on a stipulated number of traction DC links, preferably on a single traction DC link or, optionally, are individually routed to one of the traction DC links, in the event that the number thereof corresponds to the number of individual switches. Advantageously, a specific configuration of the protective circuit can be executed in accordance with a specific application.

The invention is described in greater detail hereinafter with reference to the attached figures, with respect to exemplary embodiments. In the figures:

FIG. 1 shows a schematic representation of a rail vehicle having a conventional power supply device with a traction accumulator;

FIG. 2 shows a schematic representation of a conventional power supply with current fuses;

FIG. 3 shows a schematic representation of a power supply device according to one exemplary embodiment of the invention;

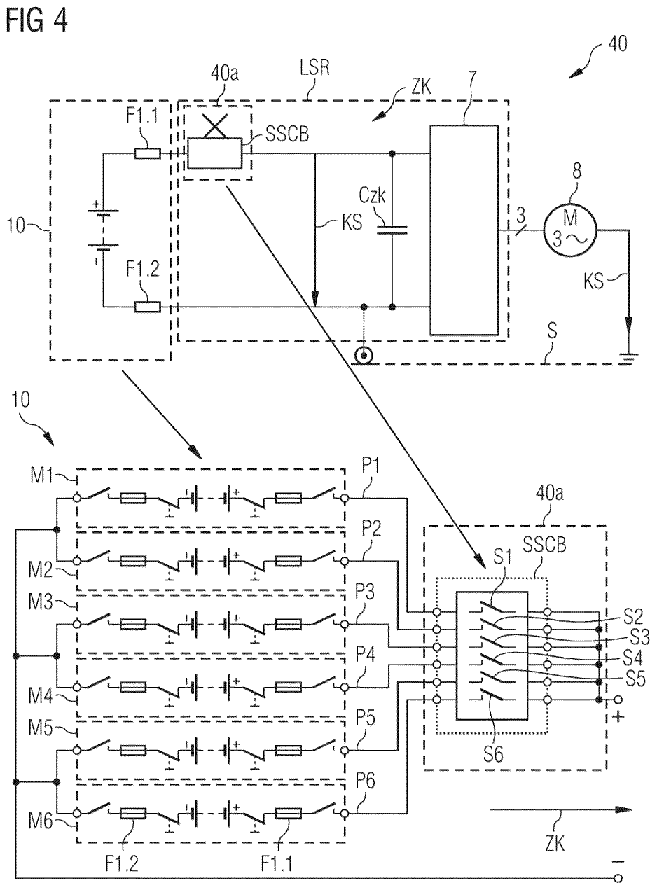

FIG. 4 shows a detailed representation of a circuit-breaker of the power supply device represented according to FIG. 3;

FIG. 5 shows a protective circuit having a circuit-breaker with a multi-phase protective arrangement at the input and output thereof;

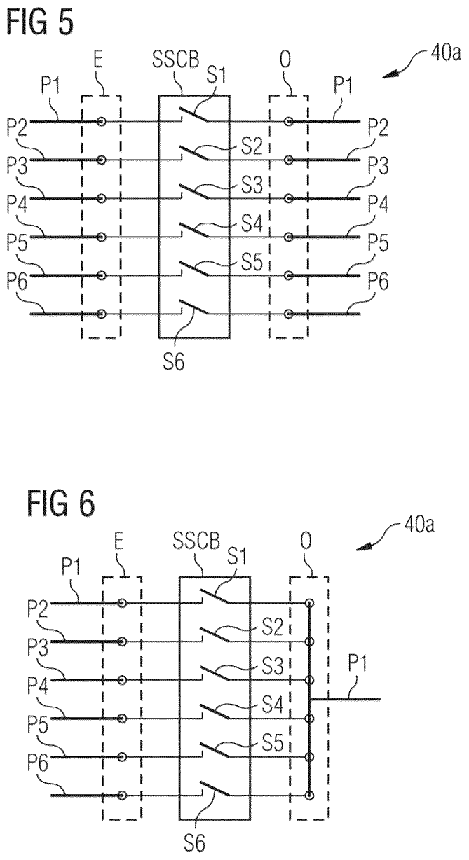

FIG. 6 shows a protective circuit having a circuit-breaker with a multi-phase protective arrangement at the input thereof, and a single-phase protective arrangement at the output thereof;

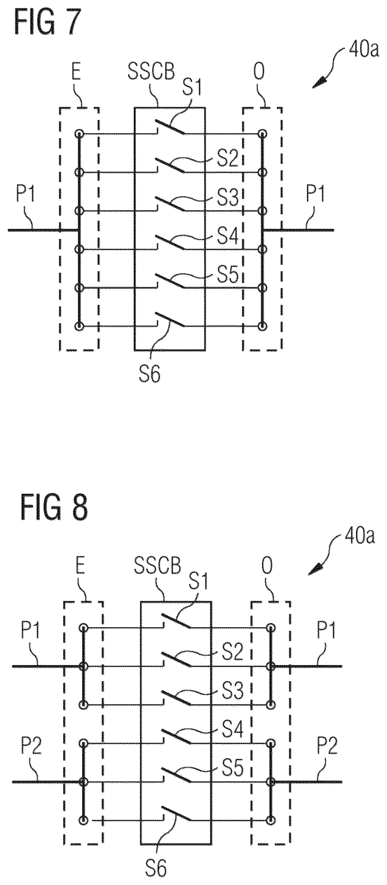

FIG. 7 shows a protective circuit having a circuit-breaker with a single-phase protective arrangement at the input and output thereof;

FIG. 8 shows a protective circuit having a circuit-breaker with a two-phase protective arrangement at the input and output thereof;

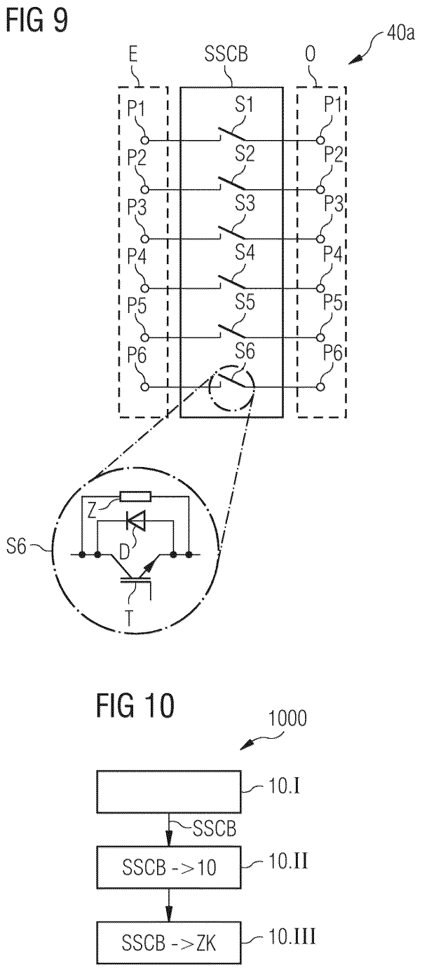

FIG. 9 shows an enlarged representation of an individual switch of a circuit-breaker;

FIG. 10 shows a flow diagram which illustrates a method for producing a protective circuit for a traction accumulator according to one exemplary embodiment of the invention.

FIG. 1 illustrates a schematic representation of electrically powered vehicle 1, in the present case a conventional electrified rail vehicle 1, having a traction battery 10. The electrified rail vehicle 1, for the supply thereof with electrical energy from the AC traction power supply grid, comprises a pantograph 2 which, via a power breaker 3, is electrically connected to a primary transformer 4. The primary transformer 4 transforms the high voltage of the AC traction power supply grid into a lower AC voltage which, by means of a four-quadrant converter 5, is then converted into a traction DC link DC voltage of the order of 2 to 4 kV for a traction DC link ZK. Traction devices 8, i.e. in particular drive motors, via pulse-controlled inverters, in particular pulse-controlled drive inverters 7, are supplied with three-phase current by the traction DC link. Moreover, a DC connection is also provided between the traction DC link ZK and the traction battery 10 via a DC-DC converter 9. The traction DC link ZK is moreover connected to an (unrepresented) on-board three-phase current system via an (unrepresented) auxiliary converter.

FIG. 2 shows a schematic representation of a conventional power supply circuit 30 having current fuses F1.1, F1.2 by way of one-time fuses. The power supply circuit 30 comprises a traction accumulator 10 having a positive pole and a negative pole. At both poles, the traction accumulator 10 respectively comprises a one-time fuse F1.1, F1.2, which fuse, however, further to an overcurrent or a short-circuit, can no longer be reset to its original state, and must therefore be replaced. An element of the power supply circuit 30 is also a centrally represented traction DC link ZK having a capacitance Czk and a pulse-controlled drive inverter 7 which converts the DC current of the traction DC link ZK into a three-phase current. The three-phase current (symbolized in FIG. 2 by a “3”) is employed by a traction device, in the present case an electric motor 8, for traction. The power supply circuit 30 is electrically connected to ground via the rails S, i.e. the negative pole of the traction accumulator 10 is grounded.

FIG. 3 shows a schematic representation of a power supply device 40 according to one exemplary embodiment of the invention. The power supply device 40 represented in FIG. 3 is distinguished from the conventional power supply circuit 30 represented according to FIG. 3 wherein it additionally comprises the protective circuit 40a having a semiconductor-based circuit-breaker SSCB. The circuit-breaker SSCB is electrically connected to a one-time fuse F1.1, i.e. to one of the two one-time fuses F1.1, F1.2 on the side of the positive pole of the traction accumulator 10 (represented in FIG. 3 on the upper side of the illustration). The circuit-breaker SSCB responds to a rise in a short-circuit current, and thus prevents both an excessively high electric current and a burn-out of the one-time fuse F1.1, such that the latter remains intact, even in the event of a short-circuit. The protective circuit 40a is arranged on a load current converter LSR. The load current converter comprises further electronic components such as, for example, the traction DC link ZK represented in FIG. 3 and the pulse-controlled drive inverter 7 represented in FIG. 3.

In FIG. 4, in addition to the schematic representation of a power supply device 40 according to one exemplary embodiment of the invention which is already known from FIG. 3, in the lower section, illustrates a detailed representation of the protective circuit 40 a having the semiconductor-based circuit-breaker SSCB and the traction accumulator 10 of the power supply device 40 previously represented in FIG. 3.

The traction accumulator 10 comprises a plurality of modules M1, . . . , M6 which are mutually connected in parallel. The semiconductor-based circuit-breaker SSCB of the protective circuit 40a comprises a plurality of individual circuit-breakers S1, S2, . . . , S6 which, via individual phases P1, . . . , P6, are electrically connected to the modules M1, . . . , M6 and are respectively assigned thereto. Each of the individual modules M1, . . . , M6 of the traction accumulator 10 can thus be separately protected, or each of the individual phases P1, . . . , P6 can be individually interrupted. In the event of a short-circuit in the traction DC link ZK, for example as a result of a ground fault in the motor 8, each individual circuit-breaker S1, S2, . . . , S6 trips sufficiently promptly such that the rise in short-circuit currents is not sufficiently rapid to trip fuses in the battery spurs. Moreover, as a result of this very rapid interruption, the magnitude of short-circuit currents, vis-à-vis an arrangement having a one-time fuse F1.1 only, for example a fusible link, is reduced. Further to the clearance of the fault, the traction accumulator 10, or one of the modules M1, M2, . . . , M6 thereof, can be reclosed by means of the circuit-breaker SSCB or by means of one of the individual switches S1, S2, . . . , S6. A short-circuit-proof power supply circuit or power supply device 40 is thus formed, i.e. a short-circuit can occur an arbitrary number of times, with no consequent tripping of a fuse or damage to the traction accumulator 10. The circuit-breaker SSCB can thus execute the selective switch-off of phases which are affected by a defect.

FIG. 5 illustrates a schematic representation of a protective circuit 40a having a multi-phase protective arrangement of a circuit-breaker SSCB at the input and output thereof, according to an exemplary embodiment of the invention. In the protective arrangement represented according to FIG. 5, all the individual switches S1, S2, . . . , S6 are wired in a mutually independent manner. The number of terminals of the input E and the number of terminals of the output 0 of the circuit-breaker SSCB corresponds to the number of individual switches S1, S2, . . . , S6. The individual SSCB switches S1, S2, . . . , S6, for example, can be assigned to independent traction DC links ZK and different loads.

FIG. 6 shows a schematic representation of a protective circuit 40a having a circuit-breaker SSCB with a multi-phase protective arrangement at the input E thereof and a single-phase protective arrangement at the output O thereof. A protective arrangement of this type can be employed, for example, for the power supply device 40 represented in FIG. 3 and FIG. 4, wherein all six modules M1, M2, . . . , M6 of the traction accumulator 10 are connected on a single DC link ZK. In this case, selective disconnection of individual phases or of individual modules M1, M2, . . . , M6 is enabled. According to this variant, the chip surface of the circuit-breaker SSCB is utilized in an optimum manner.

FIG. 7 shows a schematic representation of a protective circuit 40a having a circuit-breaker SSCB having a single-phase protective arrangement at the input E thereof and a single-phase protective arrangement at the output O thereof. By means of this protective arrangement, it is achieved that the action of the plurality of individual switches S1, S2, . . . , S6 of the circuit-breaker SSCB corresponds to the action of a single individual switch having a high current capacitor.

FIG. 8 shows a schematic representation of a protective circuit 40a having a circuit-breaker SSCB with a two-phase protective arrangement at the input E thereof and a two-phase protective arrangement at the output O thereof. In the configuration represented according to FIG. 8, the external action corresponds to that of two independent and parallel-connected “half-sized” breakers.

FIG. 9 shows a representation of a protective circuit 40a having a circuit-breaker with a protective arrangement represented according to FIG. 5, wherein one of the six parallel-connected individual switches S1, S2, . . . , S6, the sixth individual switch S6, is represented in detail.

Each of the six individual switches S1, S2, . . . , S6 comprises a transistor T and a reverse-bias diode D which is parallel-connected thereto. Each individual switch further comprises a supplementary protective element Z. The supplementary protective element Z is designed to limit voltage spikes, and is preferably implemented in the form of a “snubber capacitor” or a varistor. The individual switches S1, S2, . . . , S6 are arranged on an (unrepresented) common heat sink. The circuit-breaker moreover comprises an (unrepresented) high-speed current measurement unit, and an (unrepresented) evaluation and actuation component. Cooling of the circuit-breaker SSCB is executed by means of a cooling plate on which the circuit-breaker SSCB is arranged. In order to enable the individual disconnection of each phase, the current in each individual switch S1, S2, . . . , S6 is evaluated, and each individual switch can be individually actuated.

This arrangement is interface-compatible with existing modular current converter systems. A modular current converter system of this type comprises semiconductor modules of identical dimensions, the circuit-breaker SSCB and multiple further components from which, for example, a four-quadrant converter or pulse-controlled converter can be constituted, and control technology. These components or modules are then installed, in combination, in a current converter cabinet, as an element of a load current converter LSR. This arrangement is interface-compatible with the dimensions of the fixing module unit, cooling connections and control interface of the load current converter.

In FIG. 10, a flow diagram 1000 is represented which illustrates a method for producing a protective circuit for a traction accumulator according to one exemplary embodiment of the invention.

In step 10.I of the method according to the invention, a semiconductor-based circuit-breaker SSCB is produced for a traction accumulator 10 which, in the present exemplary embodiment, comprises six modules M1, M2, . . . , M6. The semiconductor-based circuit-breaker SSCB is configured with six parallel-connected individual switches S1, S2, . . . , S6, an input E and an output O. A circuit-braker SSCB of this type is exemplarily represented in FIG. 6.

Thereafter, in step 10.II, the modules of the traction accumulator 10 are electrically connected on the positive pole-side to the input E of the semiconductor-based circuit-breaker SSCB. The individual switches S1, S2, . . . , S6 of the semiconductor-based circuit-breaker SSCB are respectively electrically connected to the different modules M1, M2, . . . , M6 of the traction accumulator 10.

In step 10.III, a connection of the output O of the semiconductor-based circuit-breaker SSCB to a traction DC link ZK is executed wherein, according to the exemplary embodiment represented in FIG. 10, all the individual switches S1, S2, . . . , S6 are consolidated on a single traction DC link ZK. The protective circuit 40a thus configured corresponds to the protective circuit 40a illustrated in FIG. 6.

In conclusion, it should be further observed that the above-mentioned method and devices represent only preferred exemplary embodiments of the invention, and that the invention can be varied by a person skilled in the art, without departing from the scope of the invention as provided in the claims. In the interests of completeness, it is further observed that the employment of the indefinite article “a” or “an” does not exclude the presence of a plurality of the features concerned. Likewise, the term “unit” does not exclude the formation thereof by multiple components, which components, optionally, can also be spatially distributed. Independently of the grammatical gender of a specific concept, persons having a male, female or another gender identity are also included therein.

1-14. (canceled)

15. A protective circuit for a traction accumulator with a positive pole and a negative pole, the protective circuit comprising:
a semiconductor circuit-breaker which is electrically connected to the positive pole of the traction accumulator, said semiconductor circuit-breaker having an input and an output;
wherein said input of said semiconductor circuit-breaker is electrically connected to the positive pole of the traction accumulator;
said semiconductor circuit-breaker including a plurality of individual switches connected in parallel with one another and commonly arranged on a common heat sink.

16. A protective circuit system, comprising:
a protective circuit for a traction accumulator with a positive pole and a negative pole, the protective circuit including:
a semiconductor circuit-breaker which is electrically connected to the positive pole of the traction accumulator, said semiconductor circuit-breaker having an input and an output;
wherein said input of said semiconductor circuit-breaker is electrically connected to the positive pole of the traction accumulator;
said semiconductor circuit-breaker including a plurality of individual switches connected in parallel with one another and commonly arranged on a common heat sink; and
a traction battery having a plurality of parallel-connected modules, and wherein at least two of said parallel-connected modules are electrically connected to different individual switches of said semiconductor circuit-breaker.

17. The protective circuit system according to claim 16, wherein each of said parallel-connected modules is electrically connected to a different individual switch of said semiconductor circuit-breaker.

18. The protective circuit according to claim 15, wherein said output comprises a plurality of parallel-connected terminals which are respectively electrically connected to at least one of said parallel-connected individual switches.

19. The protective circuit according to claim 18, wherein a number of said parallel-connected terminals is lower than a number of said parallel-connected individual switches.

20. The protective circuit according to claim 19, wherein said output comprises exactly one terminal which is electrically connected to said plurality of parallel-connected individual switches.

21. The protective circuit according to claim 15, wherein said input comprises a plurality of parallel-connected terminals, and a number of said terminals of said input is equal to a number of said parallel-connected individual switches of said semiconductor circuit-breaker.

22. The protective circuit according to claim 15, wherein said input comprises a plurality of parallel-connected terminals, and a number of said terminals of said input is lower than a number of said parallel-connected individual switches of said semiconductor circuit-breaker.

23. The protective circuit system according to claim 16, wherein said input comprises a plurality of parallel-connected terminals, and a number of said terminals is equal to a number of said parallel-connected modules of said traction accumulator.

24. A power supply device, comprising:
a traction accumulator having a positive pole and a negative pole;
a protective circuit according to claim 15 connected to said traction accumulator;
a DC current-based traction DC link electrically connected to said traction accumulator and to said protective circuit; and
a pulse-controlled inverter for transforming a direct current of said traction DC link into a three-phase alternating current for traction.

25. An electrically powered vehicle, comprising:
a traction device; and
a power supply device for supplying energy to said traction device, said power supply device having:
a traction accumulator with a positive pole and a negative pole;
a protective circuit according to claim 15 connected to said traction accumulator;
a DC current-based traction DC link electrically connected to said traction accumulator and to said protective circuit; and
a pulse-controlled inverter for transforming a direct current of said traction DC link into a three-phase alternating current for traction.

26. A method of producing a protective circuit for a traction accumulator, which has a positive pole and a negative pole, the method comprising the following steps:
producing a semiconductor circuit-breaker with an input and an output;
electrically connecting the input of the semi-conductor-circuit-breaker to the positive pole of the traction accumulator; and
configuring the semiconductor circuit-breaker with a plurality of parallel-connected individual switches and arranging the individual switches on a common heat sink.
